(19) United States
(12) Patent Application Publication
(10) Pub. No.: US 2019/0109367 A1
(43) Pub. Date: Apr. 11, 2019

(54) WEARABLE DEVICE

(71) Applicant: Quanta Computer Inc., Taoyuan City (TW)

(72) Inventors: Chih-Tsung TSENG, Taoyuan City (TW); Chung-Ting HUNG, Taoyuan City (TW)

(21) Appl. No.: 15/867,151

(22) Filed: Jan. 10, 2018

(30) Foreign Application Priority Data
Oct. 5, 2017 (TW) 106134342

(51) Int. Cl. H01Q 1/27; H01Q 7/00; H01Q 1/24; H01Q 1/38

(52) U.S. Cl. CPC H01Q 1/273; H01Q 7/00; H01Q 5/378; H01Q 1/38; H01Q 1/241

(57) ABSTRACT

A wearable device includes a nonconductive back cover, a metal loop, a PCB (Printed Circuit Board), a feeding element, and a shorting element. The nonconductive back cover substantially has a hollow structure. The metal loop is disposed on the nonconductive back cover. The metal loop has a feeding point and a grounding point. The PCB is disposed inside the nonconductive back cover. The PCB includes a ground plane. A signal source is coupled through the feeding element to the feeding point of the metal loop. The grounding point of the metal loop is coupled through the shorting element to the ground plane. An antenna structure is formed by the metal loop, the feeding element, and the shorting element.

### CROSS REFERENCE TO RELATED APPLICATIONS

This Application claims priority of Taiwan Patent Application No. 106134342 filed on Oct. 5, 2017, the entirety of which is incorporated by reference herein.

### BACKGROUND OF THE INVENTION

### Field of the Invention

The disclosure generally relates to a wearable device, and more specifically, to a wearable device including an antenna structure.

### Description of the Related Art

With the progress of mobile communication technology, mobile devices such as portable computers, mobile phones, tablet computers, multimedia players, and other hybrid functional mobile devices have become common. To satisfy the demand of users, mobile devices can usually perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi and Bluetooth systems and using frequency bands of 2.4 GHz, 5.2 GHz, and 5.8 GHz.

According to some research reports, researchers predict that the next generation of mobile devices will be “wearable devices”. For example, wireless communication may be applied to watches, glasses, and even clothes in the future. However, watches, for example, do not have a large enough space to accommodate antennas for wireless communication. Accordingly, this has become a critical challenge for antenna designers.

BRIEF SUMMARY OF THE INVENTION

In a preferred embodiment, the disclosure is directed to a wearable device including a nonconductive back cover, a metal loop, a PCB (Printed Circuit Board), a feeding element, and a shorting element. The nonconductive back cover substantially has a hollow structure. The metal loop is disposed on the nonconductive back cover. The metal loop has a feeding point and a grounding point. The PCB is disposed inside the nonconductive back cover. The PCB includes a ground plane. A signal source is coupled through the feeding element to the feeding point of the metal loop. The grounding point of the metal loop is coupled through the shorting element to the ground plane. An antenna structure is formed by the metal loop, the feeding element, and the shorting element.

In some embodiments, the wearable device is a watch, and the metal loop is a watch bezel.

In some embodiments, each of the feeding element and the shorting element is a metal spring, a metal screw, or a metal pogo pin.

In some embodiments, the nonconductive back cover is substantially a box without a lid, and the metal loop is disposed at an open side of the box.

In some embodiments, the wearable device further includes a transparent element. The transparent element is surrounded by the metal loop.

In some embodiments, the wearable device further includes a parasitic element coupled to the ground plane. An extension portion of the antenna structure is formed by the parasitic element.

In some embodiments, the antenna structure covers a first frequency band, a second frequency band, and a third frequency band.

In some embodiments, the first frequency band is substantially from 746 MHz to 787 MHz. The second frequency band is substantially from 2400 MHz to 2500 MHz. The third frequency band is substantially at 1575 MHz.

In some embodiments, the metal loop is excited to generate the first frequency band and the second frequency band.

In some embodiments, the parasitic element is excited to generate the third frequency band.

### BRIEF DESCRIPTION OF DRAWINGS

The invention can be more fully understood by reading the subsequent detailed description and examples with references made to the accompanying drawings, wherein:

FIG. 1A is a top view of a wearable device according to an embodiment of the invention;

FIG. 1B is a side view of a wearable device according to an embodiment of the invention;

FIG. 2 is a diagram of VSWR (Voltage Standing Wave Ratio) of an antenna structure of a wearable device according to an embodiment of the invention;

FIG. 3A is a top view of a wearable device according to an embodiment of the invention;

FIG. 3B is a side view of a wearable device according to an embodiment of the invention;

FIG. 4 is a diagram of VSWR of an antenna structure of a wearable device according to an embodiment of the invention;

FIG. 5 is a top view of a wearable device according to an embodiment of the invention; and

FIG. 6 is a top view of a wearable device according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

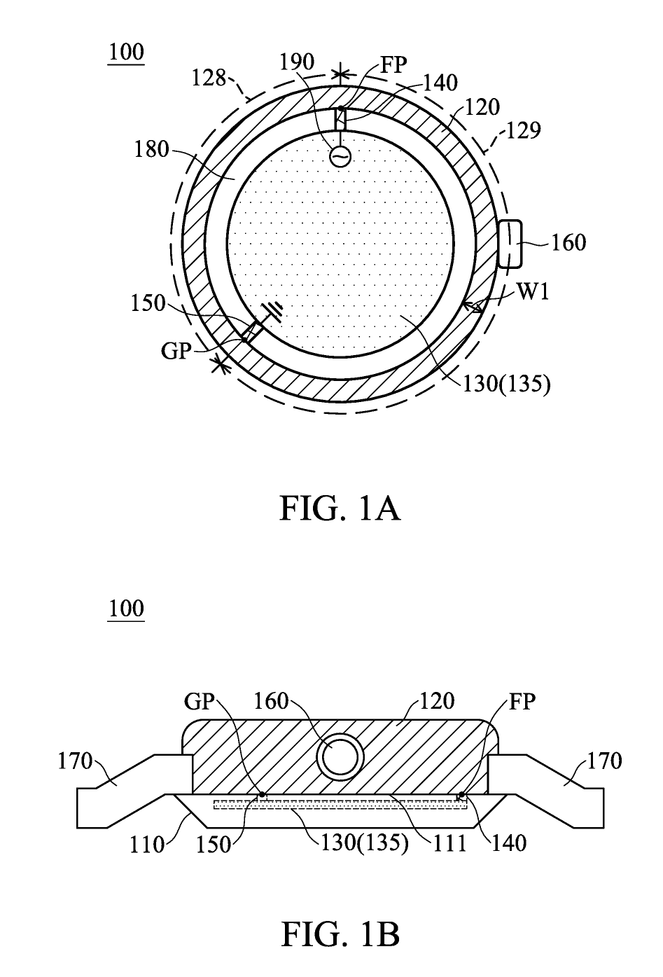

FIG. 1A is a top view of a wearable device 100 according to an embodiment of the invention. FIG. 1B is a side view of the wearable device 100 according to an embodiment of the invention. Please refer to FIG. 1A and FIG. 1B together. In a preferred embodiment, the wearable device 100 is a wrist-wearable device, such as a smart watch or a smart sporty bracelet. As shown in FIG. 1A and FIG. 1B, the wearable device 100 at least includes a nonconductive back cover 110, a metal loop 120, a PCB (Printed Circuit Board) 130, a feeding element 140, and a shorting element 150.

The nonconductive back cover 110 may be made of a plastic material. The nonconductive back cover 110 substantially has a hollow structure. The metal loop 120 may be made of copper, silver, aluminum, iron, or their alloys. The metal loop 120 may substantially have a circular shape, a square shape, a rectangular shape, an equilateral triangular shape, or an elliptical shape. If the wearable device 100 is a watch, the metal loop 120 may be a watch bezel. The shapes, patterns, and surface treatments of the nonconductive back cover 110 and the metal loop 120 are not limited in the invention. The metal loop 120 is disposed on the nonconductive back cover 110. The metal loop 120 has a feeding point FP and a grounding point GP which have different positions from each other. The PCB 130 may also substantially have a circular shape, a square shape, a rectangular shape, an equilateral triangular shape, or an elliptical shape. The PCB 130 is disposed inside the nonconductive back cover 110. The PCB 130 includes a ground plane 135. There may be a variety of electronic components disposed on the PCB 130. For example, a signal source 190 may be disposed on the PCB 130. The signal source 190 may be an RF (Radio Frequency) module for generating a transmission signal or for processing a reception signal. Each of the feeding element 140 and the shorting element 150 may be a metal spring, a metal screw, or a metal pogo pin, but it is not limited thereto. The signal source 190 is coupled through the feeding element 140 to the feeding point FP of the metal loop 120. The grounding point GP of the metal loop 120 is coupled through the shorting point 150 to the ground plane 135. In a preferred embodiment, an antenna structure of the wearable device 100 is formed by the metal loop 120, the feeding element 140, and the shorting element 150.

In some embodiments, the nonconductive back cover 110 is substantially a box without a lid (e.g., like a bowl shape having a circular opening), and the metal loop 120 is disposed at an open side 111 of the box without the lid. The nonconductive back cover 110 can accommodate a variety of device components, such as a battery, an hour hand, a minute hand, a second hand, an RF module, a signal processing module, a counter, a processor, a thermometer, and/or a barometer (not shown). In some embodiments, the metal loop 120 is substantially a circular loop, and it may fit a circular opening of the nonconductive back cover 110.

In some embodiments, the wearable device 100 further includes a knob 160, a watchband 170, and a transparent element 180. The knob 160 may be embedded in a side opening of the metal loop 120, and it may be used as a time tuner. The watchband 170 may be connected to two opposite sides of the metal loop 120, so that the user can wear the wearable device 100 on the wrist using the watchband 170. The transparent element 180 may be a watch surface glass or a transparent plastic board. The transparent element 180 may be disposed inside the metal loop 120, and it may be surrounded by the metal loop 120. Other watch components, such as an hour hand, a minute hand, a second hand, or a digital display device, may all be disposed under the transparent element 180 for the user to observe them. It should be understood that the wearable device 100 may further include other components, such as a waterproof housing or a buckle, although these components are not displayed in FIG. 1A and FIG. 1B.

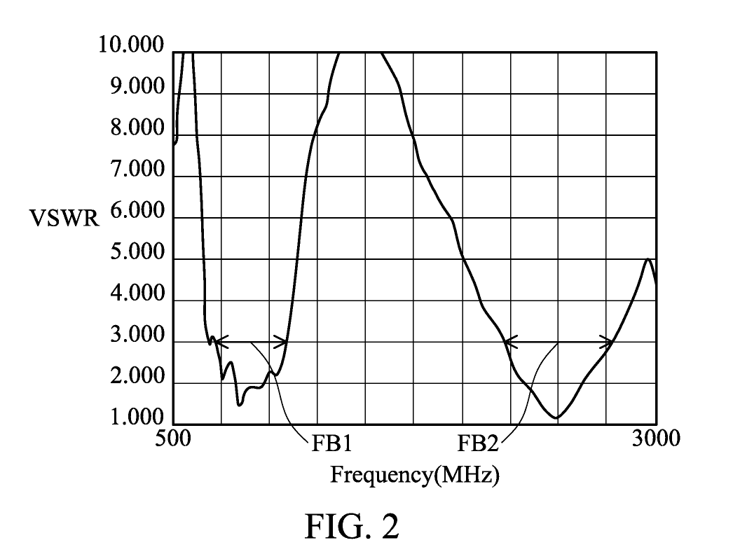

FIG. 2 is a diagram of VSWR (Voltage Standing Wave Ratio) of the antenna structure of the wearable device 100 according to an embodiment of the invention. The horizontal axis represents the operation frequency (MHz), and the vertical axis represents the VSWR. According to the measurement result of FIG. 2, when the metal loop 120 of the wearable device 100 is fed from the signal source 190, the antenna structure can cover a first frequency band FB1 and a second frequency band FB2. For example, the first frequency band FB1 may be substantially from 746 MHz to 787 MHz, and the second frequency band FB2 may be substantially from 2400 MHz to 2500 MHz. As a result, the wearable device 100 of the invention can support at least the dual-band operations of LTE (Long Term Evolution) Band 13 and WLAN (Wireless Local Area Networks) 2.4 GHz. The aforementioned frequency ranges are adjustable according to different requirements. Since the metal loop 120 is implemented with a light and thin metal piece and contributes to the aesthetic design of the wearable device 100, the present invention has the advantages of minimizing the antenna size, keeping the antenna bandwidth, reducing the manufacturing cost, and improving the device's appearance, and it is suitable for application in a wide variety of small, smart, wearable devices.

Please refer to FIG. 1A and FIG. 1B again to understand antenna theory and design method of the invention. Due to the design characteristics of the feeding point FP and the grounding point GP of the metal loop 120, the antenna structure of the wearable device 100 has a first resonant path 128 and a second resonant path 129. The first resonant path 128 is a shorter portion of the path from the feeding point FP to the grounding point FP of the metal loop 120. The second resonant path 129 is a longer portion of the path from the feeding point FP to the grounding point GP of the metal loop 120. Specifically, the first resonant path 128 may have a first arc-shape which is smaller than 180 degrees (e.g., about 120 degrees), and the second resonant path 129 may have a second arc-shape which is larger than 180 degrees (e.g., about 240 degrees). A combination of the first resonant path 128 and the second resonant path 129 substantially covers a complete metal loop 120 (e.g., about 360 degrees). With respect to antenna theory, the metal loop 120 is excited to generate both the first frequency band FB1 and the second frequency band FB2. Specifically, the second resonant path 129 of the metal loop 120 is excited to generate the first frequency band FB1, and the first resonant path 128 of the metal loop 120 is excited to generate the second frequency band FB2. Therefore, the designer can appropriately change the positions of the feeding point FP and the grounding point GP, so as to control the ranges of the operation frequency bands of the antenna structure. With respect to the element sizes, the length of the first resonant path 128 may be substantially equal to 0.25 wavelength (λ/4) of the second frequency band FB2, the length of the second resonant path 129 may be substantially equal to 0.25 wavelength (λ/4) of the first frequency band FB1, and the width W1 of the metal loop 120 may be substantially from 2 mm to 3 mm. The above element sizes are calculated and obtained according to many experiment results, and they help to optimize the impedance matching of the antenna structure.

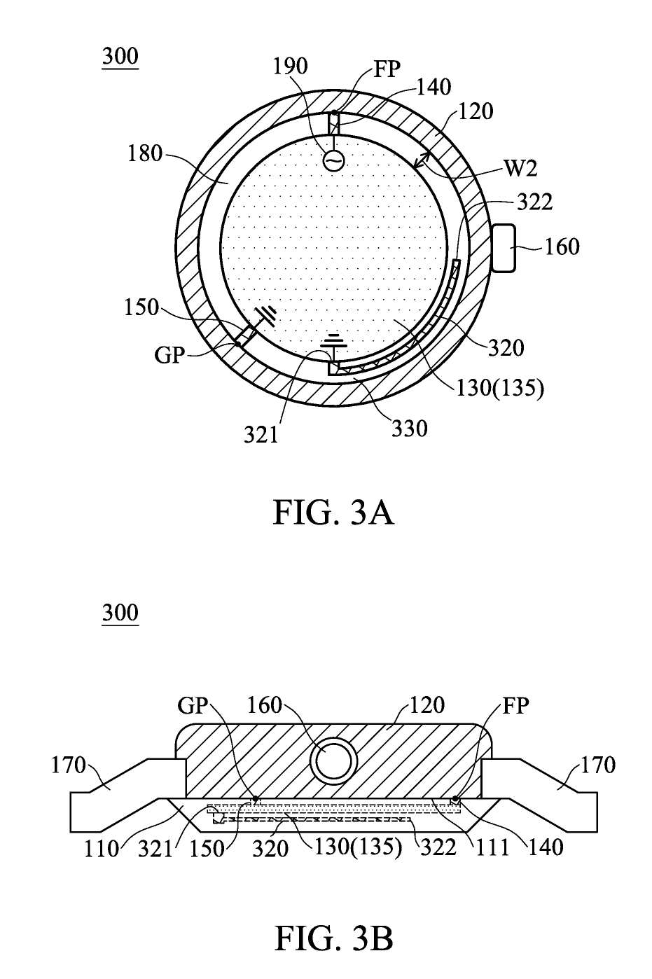

FIG. 3A is a top view of a wearable device 300 according to an embodiment of the invention. FIG. 3B is a side view of the wearable device 300 according to an embodiment of the invention. FIG. 3A and FIG. 3B are similar to FIG. 1A and FIG. 1B. In the embodiment of FIG. 3A and FIG. 3B, the wearable device 300 further includes a parasitic element 320, which is made of a metal material. For example, the parasitic element 320 may substantially have an L-shape or a quarter-arc-shape, but it is not limited thereto. Specifically, the parasitic element 320 has a first end 321 and a second end 322. The first end 321 of the parasitic element 320 is coupled to the ground plane 135, and the second end 322 of the parasitic element 320 is an open end, which substantially extends along the metal loop 120. The parasitic element 320 is disposed within a non-metal clearance region 330 between the metal loop 120 and the PCB 130. The non-metal clearance region 330 may substantially have a circular-loop shape, and its width W2 may be substantially from 1 mm to 2 mm. In a preferred embodiment, an extension portion of an antenna structure of the wearable device 300 is formed by the parasitic element 320. The parasitic element 320 is excited by the metal loop 120 using a coupling mechanism, so as to increase the operation bandwidth of the antenna structure.

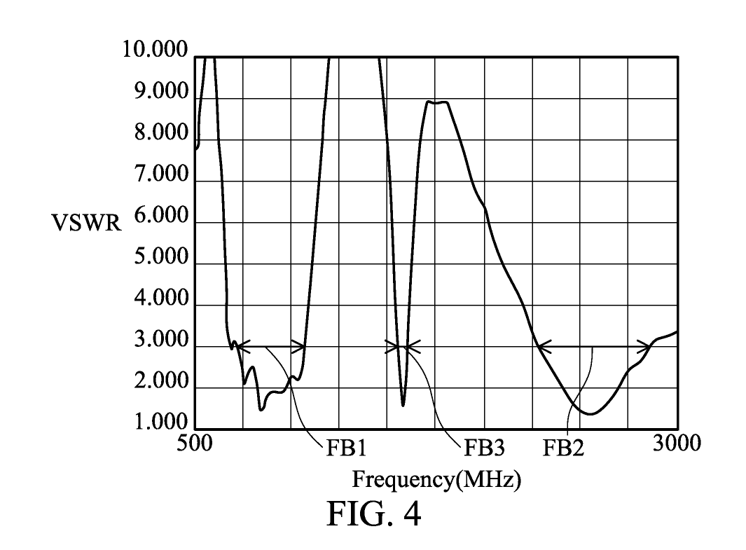

FIG. 4 is a diagram of VSWR of the antenna structure of the wearable device 300 according to an embodiment of the invention. The horizontal axis represents the operation frequency (MHz), and the vertical axis represents the VSWR. According to the measurement result of FIG. 4, when the metal loop 120 of the wearable device 300 is fed from the signal source 190, in addition to the first frequency band FB1 and the second frequency band FB2, the antenna structure can further cover a third frequency band FB3. For example, the third frequency band FB3 may be substantially at 1575 MHz, such that the wearable device 300 of the invention can further support the application and the function of a GPS (Global Positioning System). With respect to antenna theory and the element sizes, the parasitic element 320 is excited to generate the third frequency band FB3, and the length of the parasitic element 320 (i.e., the length from the first end 321 to the second end 322) may be substantially equal to 0.25 wavelength (λ/4) of the third frequency band FB3. Other features of the wearable device 300 of FIG. 3A and FIG. 3B are similar to those of the wearable device 100 of FIG. 1A and FIG. 1B. Therefore, these embodiments can achieve similar levels of performance.

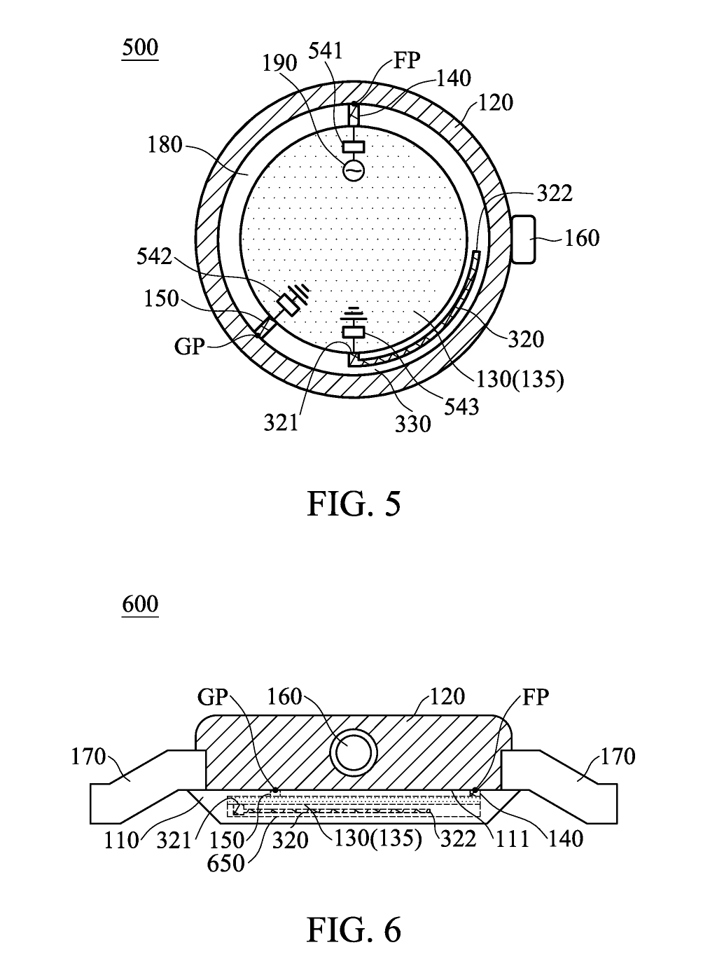

FIG. 5 is a top view of a wearable device 500 according to an embodiment of the invention. FIG. 5 is similar to FIG. 3A. In the embodiment of FIG. 5, the wearable device 500 further includes a first matching circuit 541, a second matching circuit 542, and a third matching circuit 543. The signal source 190 is coupled through the first matching circuit 541 and the feeding element 140 to the feeding point FP of the metal loop 120. The grounding point GP of the metal loop 120 is coupled through the shorting element 150 and the second matching circuit 542 to the ground plane 135. The first end 321 of the parasitic element 320 is coupled through the third matching circuit 543 to the ground plane 135. Each of the first matching circuit 541, the second matching circuit 542, and the third matching circuit 543 may be a passive element, which may include one or more capacitors and/or one or more inductors, such as chip capacitors and/or chip inductors, so as to fine-tune the lengths of resonant paths of an antenna structure of the wearable device 500. For example, if the first matching circuit 541, the second matching circuit 542, and the third matching circuit 543 are in use, the length of the metal loop 120 and the length of the parasitic element 320 will be both decreased, thereby minimizing the total size of the wearable device 500. Other features of the wearable device 500 of FIG. 5 are similar to those of the wearable device 300 of FIG. 3A and FIG. 3B. Therefore, these embodiments can achieve similar levels of performance.

FIG. 6 is a top view of a wearable device 600 according to an embodiment of the invention. FIG. 6 is similar to FIG. 3B. In the embodiment of FIG. 6, the wearable device 600 further includes a carrier element 650, which is made of a nonconductive material, such as a plastic material. The carrier element 650 may be disposed inside the nonconductive back cover 110, and it can support and affix the PCB 130. The parasitic element 320 may be formed on a sidewall of the carrier element 650 by using an LDS (Laser Direct Structuring) technique. Such a design does not additionally increase the total size of an antenna structure of the wearable device 600. Other features of the wearable device 600 of FIG. 6 are similar to those of the wearable device 300 of FIG. 3A and FIG. 3B. Therefore, these embodiments can achieve similar levels of performance.

The invention proposes a novel wearable device, which uses a no-fracture metal loop to form an antenna structure. Such a design helps to improve the consistency of the appearance of the wearable device. In addition, the antenna structure has no need to use active matching circuits for adjustment, and therefore it does not occupy additional clearance regions on a PCB. Accordingly, the invention has at least the advantages of small size, low cost, and improved appearance, and its antenna structure can still have sufficient operation bandwidth.

Note that the above element sizes, element shapes, and frequency ranges are not limitations of the invention. An antenna designer can adjust these settings or values according to different requirements. It should be understood that the wearable device and the antenna structure of the invention are not limited to the configurations of FIGS. 1-6. The invention may merely include any one or more features of any one or more embodiments of FIGS. 1-6. In other words, not all of the features shown in the figures should be implemented in the wearable device and the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A wearable device, comprising:
a nonconductive back cover, substantially having a hollow structure;
a metal loop, disposed on the nonconductive back cover, wherein the metal loop has a feeding point and a grounding point;
a PCB (Printed Circuit Board), disposed inside the nonconductive back cover, and comprising a ground plane;
a feeding element, wherein a signal source is coupled through the feeding element to the feeding point of the metal loop; and
a shorting element, wherein the grounding point of the metal loop is coupled through the shorting point to the ground plane;
wherein an antenna structure is formed by the metal loop, the feeding element, and the shorting element.

2. The wearable device as claimed in claim 1, wherein the wearable device is a watch, and the metal loop is a watch bezel.

3. The wearable device as claimed in claim 1, wherein each of the feeding element and the shorting element is a metal spring, a metal screw, or a metal pogo pin.

4. The wearable device as claimed in claim 1, wherein the nonconductive back cover is substantially a box without a lid, and the metal loop is disposed at an open side of the box.

5. The wearable device as claimed in claim 1, further comprising:
a transparent element, wherein the transparent element is surrounded by the metal loop.

6. The wearable device as claimed in claim 1, further comprising:
a parasitic element, coupled to the ground plane, wherein an extension portion of the antenna structure is formed by the parasitic element.

7. The wearable device as claimed in claim 6, wherein the antenna structure covers a first frequency band, a second frequency band, and a third frequency band.

8. The wearable device as claimed in claim 7, wherein the first frequency band is substantially from 746 MHz to 787 MHz, the second frequency band is substantially from 2400 MHz to 2500 MHz, and the third frequency band is substantially at 1575 MHz.

9. The wearable device as claimed in claim 7, wherein the metal loop is excited to generate the first frequency band and the second frequency band.

10. The wearable device as claimed in claim 7, wherein the parasitic element is
